(19) United States
(12) Patent Application Publication
(10) Pub. No.: US 2016/0225021 A1
(43) Pub. Date: Aug. 4, 2016

(54) METHOD AND SYSTEM FOR ADVERTISEMENT RETARGETING BASED ON PREDICTIVE USER INTENT PATTERNS

(71) Applicant: IPerceptions inc., Montreal (CA)

(72) Inventors: Lane Cochrane, Kirkland (CA); Audry Larocque, Ville Mont-Royal (CA); Matthew Butler, Montreal (CA); Derek Zakaib, St-Lambert (CA); Alexandre Hayon, Montreal (CA)

(21) Appl. No.: 14/612,530

(22) Filed: Feb. 3, 2015

(51) Int. Cl. G06Q 30/02; G06N 5/02

(52) U.S. Cl. CPC G06Q 30/0255; G06N 5/02

(57) ABSTRACT

Method and system for advertisement retargeting using predictive user intent patterns. A survey server collects behavioral data from a plurality of user devices visiting a website. The survey server collects survey participation data related to the visit of the website from some of the plurality of user devices, and determines an intent of corresponding users based on the survey participation data. The survey server analyzes the intent of the users and the related behavioral data to generate predictive user intent patterns. The survey server collects current behavioral data from a current user device visiting a current website. The survey server determines an intent of the user of the current user device while visiting the current website, based on the current behavioral data and the predictive user intent patterns. An advertisement server selects a retargeting advertisement directed to the current website for the current user device using the determined intent.

### TECHNICAL FIELD

The present disclosure relates to the field of on-line advertising. More specifically, the present disclosure relates to a method, computer program product and system for advertisement retargeting based on predictive user intent patterns.

### BACKGROUND

The usage of websites to make dedicated web content available to a large public is now prevalent, in relation with the widespread usage of fixed Internet access and mobile Internet access. In particular, e-commerce has become a major component of the economy, in a plurality of business areas such as for example travel agencies, on-line banking, consumer electronics and multimedia retail sales, etc. Websites in relation to professional services and administration are now also widely used to reach prospects and users.

However, the average e-commerce website conversion rate is generally a little more than 2% (according to studies). In other words, nearly all of the people who visit an e-commerce website for the first time leave without some form of desired action. Retargeting is a technique for driving customers to return to a previously visited website. Retargeted customers are four times more likely to convert than new customers who have never been exposed to a company brand (according to studies).

Behavioral data collection is a known technique for optimizing the selection of an advertisement for retargeting a potential customer to a website. Behavioral data related to a previous visit of the website by the potential customer are used to better understand the intent of the customer, in order to select the most effective retargeting advertisement. However, the collected behavioral data are not always representative of the real intent of the potential customer when visiting the website. For instance, it seems intuitive to assume through behavioral data collection that a visitor who visited the cart of an e-commerce website has an intent to purchase. However, studies have shown that 56% of visitors who visit the cart do not intend to purchase.

Furthermore, web surveys have shown that 67% of visitors who have a stated intent to purchase (as expressed in a response to a question in a web survey related to a website) do not even make it to the cart of the website. This means that a retargeting campaign leveraging behavioral data related to the cart as a trigger is neglecting the majority of visitors who intend to purchase, missing a huge conversion opportunity.

There is therefore a need for a new method, computer program product and system for advertisement retargeting based on predictive user intent patterns.

### SUMMARY

According to a first aspect, the present disclosure provides a method for advertisement retargeting based on predictive user intent patterns. The method comprises collecting behavioral data from a plurality of user devices. The behavioral data are representative of a series of actions performed by a user of each of the plurality of user devices while visiting a website. The method comprises collecting survey participation data from at least some of the plurality of user devices. The survey participation data correspond to survey information received from the users of the at least some of the plurality of user devices in relation to the visiting of the website. The method comprises determining an intent of the users of the at least some of the plurality of user devices in relation to the visiting of the website, based on the survey participation data. The method comprises analyzing the intent of the users and the related behavioral data to generate the predictive user intent patterns. The method comprises collecting current behavioral data from a current user device. The current behavioral data are representative of a series of actions performed by a user of the current user device while visiting a current website. The method comprises determining an intent of the user of the current user device in relation to the visiting of the current website based on the current behavioral data and the predictive user intent patterns. The method comprises selecting a retargeting advertisement directed to the current website for the current user device based at least on the determined intent of the user of the current device.

According to a second aspect, the present disclosure provides a computer program product comprising instructions deliverable via an electronically-readable media, such as storage media and communication links. The instructions comprised in the computer program product, when executed by a processing unit of a user device, provide for advertisement retargeting based on a determined user intent. More specifically, the instructions provide for collecting behavioral data representative of a series of actions performed by a user of the user device while visiting a website. The instructions provide for transmitting the collected behavioral data to a survey server. The survey server is capable of determining an intent of the user of the user device in relation to the visiting of the website based on the collected behavioral data and predictive user intent patterns. The instructions provide for receiving the determined intent of the user of the user device from the survey server. The instructions provide for transmitting the determined intent to an advertising server. The instructions provide for receiving a retargeting advertisement directed to the website from the advertising server. The retargeting advertisement is selected at least based on the determined intent.

According to a third aspect, the present disclosure provides a system for advertisement retargeting based on predictive user intent patterns. The system comprises a survey server and an advertisement server. The survey server comprises a communication interface for exchanging data with user devices. The survey server comprises memory for storing the predictive user intent patterns. The survey server comprises a processing unit for collecting behavioral data from a plurality of user devices. The behavioral data are representative of a series of actions performed by a user of each of the plurality of user devices while visiting a website. The processing unit also collects survey participation data from at least some of the plurality of user devices. The survey participation data correspond to survey information received from the users of the at least some of the plurality of user devices in relation to the visiting of the website. The processing unit further determines an intent of the users of the at least some of the plurality of user devices in relation to the visiting of the website, based on the survey participation data. The processing unit analyzes the intent of the users and the related behavioral data to generate the predictive user intent patterns. The processing unit also collects current behavioral data from a current user device. The current behavioral data are representative of a series of actions performed by a user of the current user device while visiting a current website. The processing unit determines an intent of the user of the current user device in relation to the visiting of the current website based on the current behavioral data and the predictive user intent patterns. The processing unit further transmits the determined intent to the current user device. The advertisement server comprises a communication interface for exchanging data with user devices. The survey server comprises a processing unit for receiving the determined intent from the current user device. The processing unit further selects a retargeting advertisement directed to the current website for the current user device based at least on the determined intent.

### BRIEF DESCRIPTION OF THE DRAWINGS

Embodiments of the disclosure will be described by way of example only with reference to the accompanying drawings, in which:

FIG. 1 illustrates a system for advertisement retargeting based on predictive user intent patterns;

FIGS. 2A and 2B illustrate a method for advertisement retargeting based on predictive user intent patterns;

FIG. 3 illustrates an example of a web survey for collecting a user intent in relation to a visit of a website; and

FIG. 4 illustrates audience segments based at least on intents of users.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the optimization of advertisement retargeting, using behavioral data and survey participation data.

The following terminology is used throughout the present disclosure:
Web survey: A web survey aims at collecting user feedback related to a visit of a website by a user. The term survey is used in a generic manner, and may include surveys, questionnaires, comment cards, etc.
Behavioral data: Data representative of a series of actions performed by a user while visiting a website. Behavioral data include visited web pages, time spent on the visited web pages, specific interactions with the visited web pages, etc. The behavioral data are generally collected from the user device by an analytic server, which further processes the data collected from a plurality of user devices visiting the web site.
Advertisement retargeting: Retargeting is a form of online advertising for keeping a brand in front of visitors, after they leave a website related to the brand, and are visiting other websites. Retargeting is generally implemented as a cookie-based technology that uses a script (e.g. Javascript code) to anonymously follow an audience all over the Web. Every time a new visitor visits a particular website, the script generates an anonymous browser cookie. Later, when the cookied visitor browses the Web, the cookie allows a retargeting provider to know when to serve advertisements, ensuring that advertisements related to the particular website (or particular brand related to the particular web site) are only served to people who have previously visited the particular site. Behavioral retargeting is a form of retargeting that leverages collected behavioral data related to the visited particular website to improve the retargeting process. The advertisement served to a specific prospect is personalized based on the behavioral data previously collected from the specific prospect.

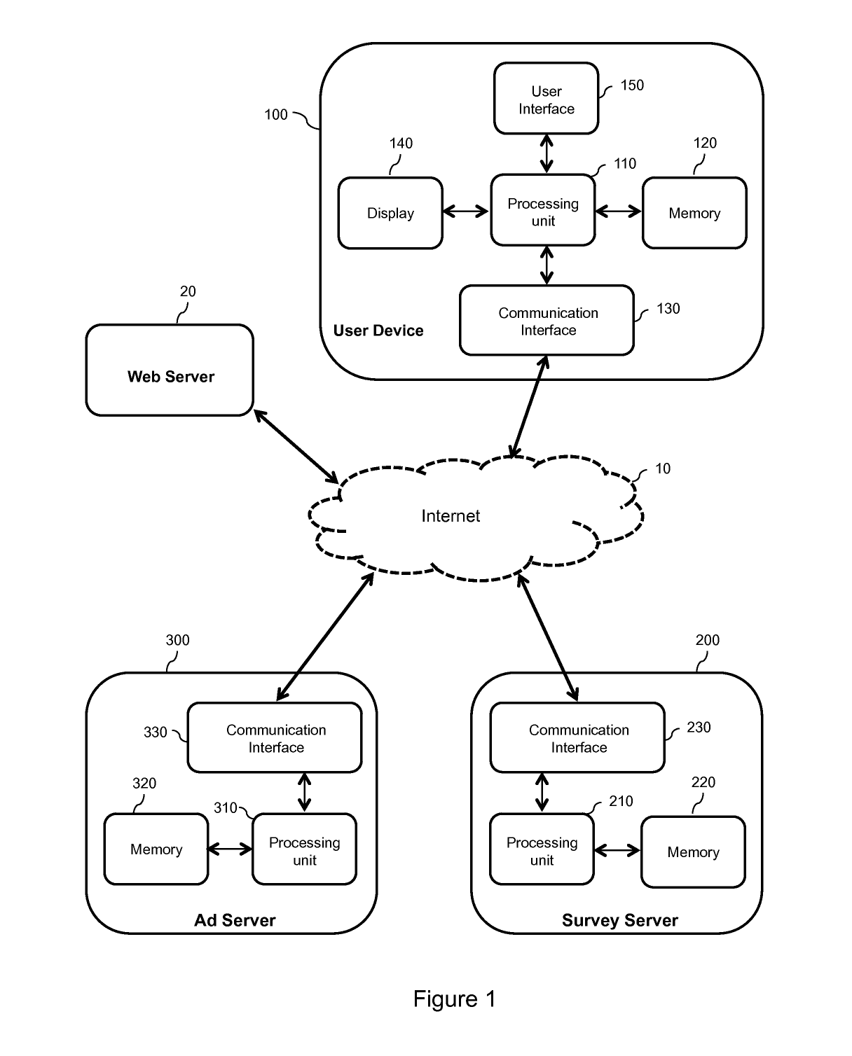

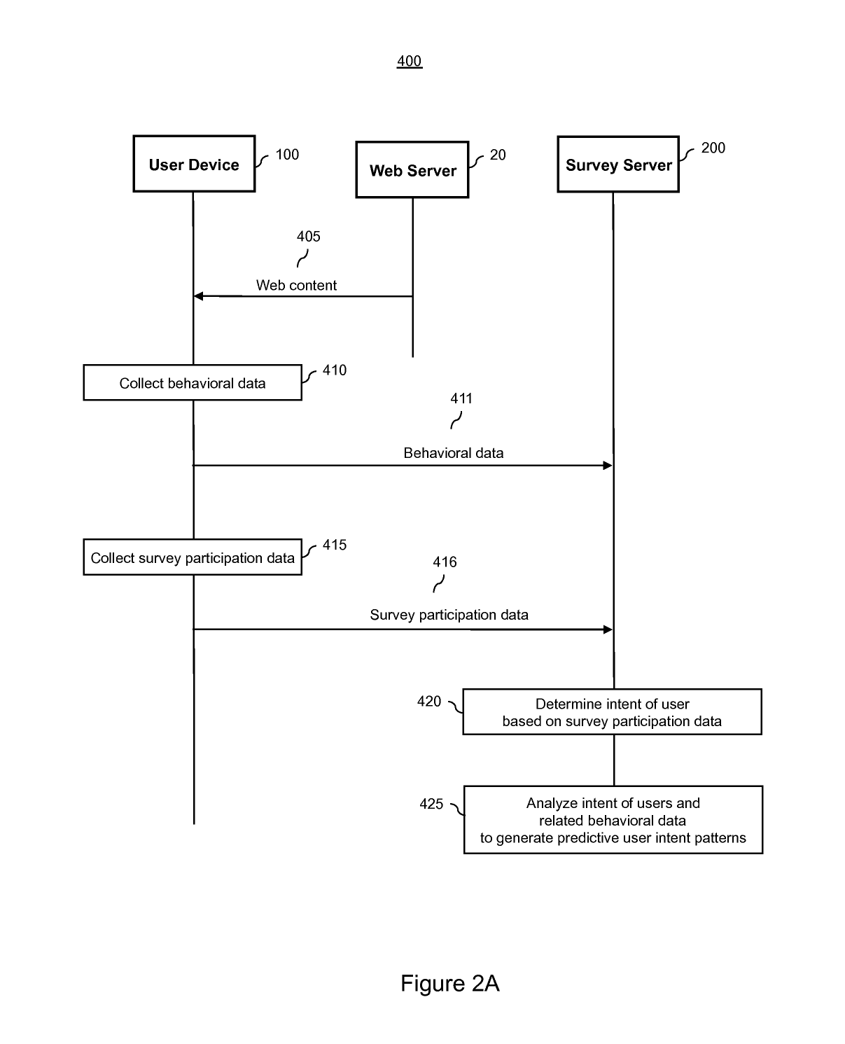

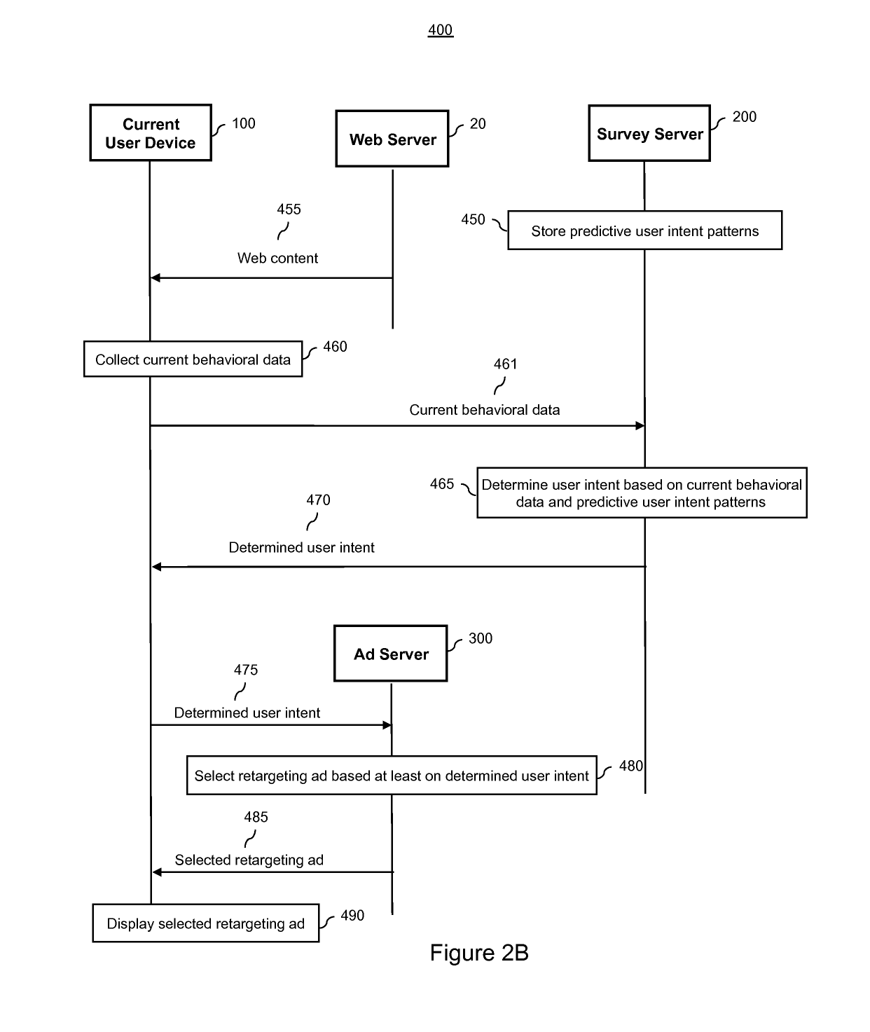

Referring now concurrently to FIGS. 1, 2A and 2B, a system and a method for advertisement retargeting based on predictive user intent patterns are represented. The system comprises a survey server 200 and an advertisement server 300. At least some of the steps of the method 400 are performed by the survey server 200 and the advertisement server 300.

The survey server 200 comprises a processing unit 210, having one or more processors (not represented in FIG. 1 for simplification purposes) capable of executing instructions of computer program(s). Each processor may further have one or several cores. The survey server 200 also comprises memory 220 for storing instructions of the computer program(s) executed by the processing unit 210, data generated by the execution of the computer program(s), data received via a communication interface 230 of the survey server 200, etc. The survey server 200 may comprise several types of memories, including volatile memory, non-volatile memory, etc. The survey server 200 further comprises the communication interface 230 (e.g. Wi-Fi interface, Ethernet interface, etc.). The communication interface 230 is used for exchanging data with other entities, such as a user device 100.

The survey server 200 exchange data with the other entities through communication links, generally referred to as the Internet 10 for simplification purposes. Such communication links may include wired (e.g. a fixed broadband network) and wireless communication links (e.g. a cellular network or a Wi-Fi network).

The survey server 200 may further comprise a display (e.g. a regular screen or a tactile screen) for displaying data generated by the processing unit 210, and a user interface (e.g. a mouse, a keyboard, a trackpad, a touchscreen, etc.) for allowing a user to interact with the survey server 200. The display and the user interface are not represented in FIG. 1 for simplification purposes.

The user device 100 may consist of a computer, a laptop, a mobile device (e.g. smartphone, tablet, etc.), an Internet connected television, etc. The user device 100 is capable of retrieving web content from a web server 20 over the Internet 10, and displaying the retrieved web content to a user of the user device 100 via a web browser. The user device 100 comprises a processing unit 110, having one or more processors (not represented in FIG. 1 for simplification purposes) capable of executing instructions of computer program(s) (e.g. the web browser). Each processor may further have one or several cores. The user device 100 also comprises memory 120 for storing instructions of the computer program(s) executed by the processing unit 110, data generated by the execution of the computer program(s), data received via a communication interface 130 of the user device 100, etc. The user device 100 may comprise several types of memories, including volatile memory, non-volatile memory, etc. The user device 100 further comprises the communication interface 130 (e.g. cellular interface, Wi-Fi interface, Ethernet interface, etc.). The communication interface is used for exchanging data over the Internet 10 with other entities, such as the web server 20, the survey server 200, and an advertisement server 300.

The user device 100 further comprises a display 140 (e.g. a regular screen or a tactile screen) for displaying data generated by the processing unit 210, web content retrieved from the web server 20, etc. The user device 100 also comprises a user interface 150 (e.g. a mouse, a keyboard, a trackpad, a touchscreen, etc.) for allowing a user to interact with the user device 100 (e.g. interactions of the user with the displayed web content).

The web server 20 generally consists of a dedicated computer with high processing capabilities, capable of hosting one or a plurality of websites. The web server 20 comprises a processing unit, memory, and a communication interface (e.g. Ethernet interface, Wi-Fi interface, etc.) for delivering web content of a hosted website to the user device 100. The components of the web server 20 are not represented in FIG. 1 for simplification purposes.

Although a single user device 100 is represented in FIG. 1, a plurality of user devices 100 exchange data with the web server 20 in relation to a visit of a particular website (hosted by the web server 20) by the plurality of user devices 100.

The advertisement server 300 comprises a processing unit 310, having one or more processors (not represented in FIG. 1 for simplification purposes) capable of executing instructions of computer program(s). Each processor may further have one or several cores. The advertisement server 300 also comprises memory 320 for storing instructions of the computer program(s) executed by the processing unit 310, data generated by the execution of the computer program(s), data received via a communication interface 330 of the advertisement server 300, etc. The advertisement server 300 may comprise several types of memories, including volatile memory, non-volatile memory, etc. The advertisement server 300 further comprises the communication interface 330 (e.g. Wi-Fi interface, Ethernet interface, etc.). The communication interface 330 is used for exchanging data over the Internet 10 with other entities, such as the user device 100. As is well known in the art, the advertisement server 300 interacts with the user device 100 over the Internet 10, for delivering advertisement(s) (e.g. a banner, a video, etc.) to the user device 100, while the user of the user device 100 is visiting a website hosted by the web server 20. The advertisements are displayed on the display 140 along with a web content of the visited web site.

The advertisement server 300 may further comprise a display (e.g. a regular screen or a tactile screen) for displaying data generated by the processing unit 310, and a user interface (e.g. a mouse, a keyboard, a trackpad, a touchscreen, etc.) for allowing a user to interact with the advertisement server 300. The display and the user interface are not represented in FIG. 1 for simplification purposes.

Referring now particularly to FIGS. 2A and 2B, the steps of the method 400 will be described. The method 400 comprises two phases: a learning phase for generating predictive user intent patterns, and an operational phase for using the generated predictive user intent patterns.

### Learning Phase (FIG. 2a)

At step 405, web content corresponding to a website is transmitted by the web server 20 to a user device 100 over the Internet 30. The website (e.g. http://www.ecommerce.com) is hosted by the web server 20 and visited by a user of the user device 100. The interactions between the user device 100 and the web server 20 for exchanging the web content are well known in the art. The web content is sent via the communication interface (not represented in FIG. 1) of the web server 20 and received via the communication interface 130 of the user device 100.

The web content may include text, image(s), video(s), icon(s), etc. The web content is displayed on the display 140 of the user device 100 by the browser executed by the processing unit 110 of the user device 100. The step of displaying the web content on the display 140 is not represented in FIG. 2A for simplification purposes. During a browsing session of the web site, a sequence of web pages of the website containing the web content is displayed on the display 140. The user of the user device 100 interacts with the web content of the webpages through the user interface 150 of the user device 100.

At steps 410 and 411, behavioral data are respectively collected by the processing unit 110 of the user device 100, and transmitted by the processing unit 110 from the user device 100 to the survey server 200. The behavioral data are representative of a series of actions performed by the user of the user device 100 while visiting the website. The behavioral data are sent via the communication interface 130 of the user device 100 and received via the communication interface 230 of the survey server 200. The type of behavioral data which can be collected is well known in the art of web analytics, and examples of such behavioral data will be provided later in the description.

In an alternative embodiment, the web server 20 performs the collection of the behavioral data, and the transmission of the behavioral data to the survey server 200 over the Internet 10. In still another alternative embodiment, the behavioral data are partially collected by the user device 100 and partially collected by the web server 20, before transmission to the survey server 200. In yet another alternative embodiment, at least some of the behavioral data (collected by the user device 100 or the web server 20) are transmitted to a third party server (e.g. an analytic server not represented in FIG. 1), where they are processed for purposes specific to the third party server. The behavioral data are further transmitted from the third party server to the survey server 200, where they are processed according to the method 400. These alternative embodiments have not been represented in the Figures for simplification purposes.

A plurality of user devices 100 visit the website and generate corresponding behavioral data. The processing unit 210 of the survey server 200 collects the behavioral data from the plurality of user devices, for further processing at step 425 of the method 400.

The behavioral data are received via the communication interface 230 of the survey server 200 and stored in the memory 220 for later use. Furthermore, the behavioral data of a specific user device 100 may be received in several bundles, and aggregated in the memory 220 using a unique identifier of the specific user device 100 (e.g. a unique session identifier or unique device identifier).

The processing unit 210 of the survey server 200 may also filter the collected behavioral data, and discard some of them based on pre-determined criteria. The criteria may include at least one of the following: incomplete data, erroneous data, irrelevant data, etc.

The user of the user device 100 also participates to a web survey related to the visit of the website, and provides survey information by participating to the web survey.

At steps 415 and 416, survey participation data are respectively collected by the processing unit 110 of the user device 100, and transmitted by the processing unit 110 from the user device 100 to the survey server 200. The survey participation data correspond to the survey information provided by the user. The survey participation data are sent via the communication interface 130 of the user device 100 and received via the communication interface 230 of the survey server 200.

An example of survey participation data comprises responses to a survey questionnaire related to the visited website, and includes at least one of the following: free-form text, ratings, selection of one or more elements among proposed alternatives, ordering of proposed elements, etc. An invitation to participate to the web survey may be prompted to the user of the user device 100 during the visit of the website, voluntarily triggered by the user of the user device 100 (e.g. through the selection of a survey icon), communicated to the user of the user device 100 in a delayed manner (e.g. through an email), etc.

Users of several user devices 100 participate to the web survey related to the website, and the several user devices 100 generate corresponding survey participation data. The processing unit 210 of the survey server 200 collects the survey participation data from the several user devices, for further processing at steps 420 and 425 of the method 400.

The survey participation data are received via the communication interface 230 of the survey server 200 and stored in the memory 220 for later use. Furthermore, the survey participation data of a specific user device 100 may be received in several bundles, and aggregated in the memory 220 using a unique identifier of the specific user device 100 (e.g. a unique session identifier or unique device identifier).

The processing unit 210 of the survey server 200 may also filter the collected survey participation data, and discard some of them based on pre-determined criteria. The criteria may include at least one of the following: incomplete data, erroneous data, irrelevant data, etc.

For a specific user device 100 for which behavioral data are collected, survey participation data may or may not be collected. For instance, if the user of the specific user device 100 is not invited to participate to the web survey, no survey participation data are collected. Similarly, if the user of the specific user device 100 is invited to participate to the web survey, but refuses to participate, no survey participation data are collected. Thus, the survey server 200 collects the behavioral data from a plurality of user devices 100, and collects the survey participation from at least some of the plurality of user devices 100.

At step 420, the processing unit 210 of the survey server 200 determines an intent of the users of the at least some of the plurality of user devices 100 in relation to the visiting of the website, based on the collected survey participation data.

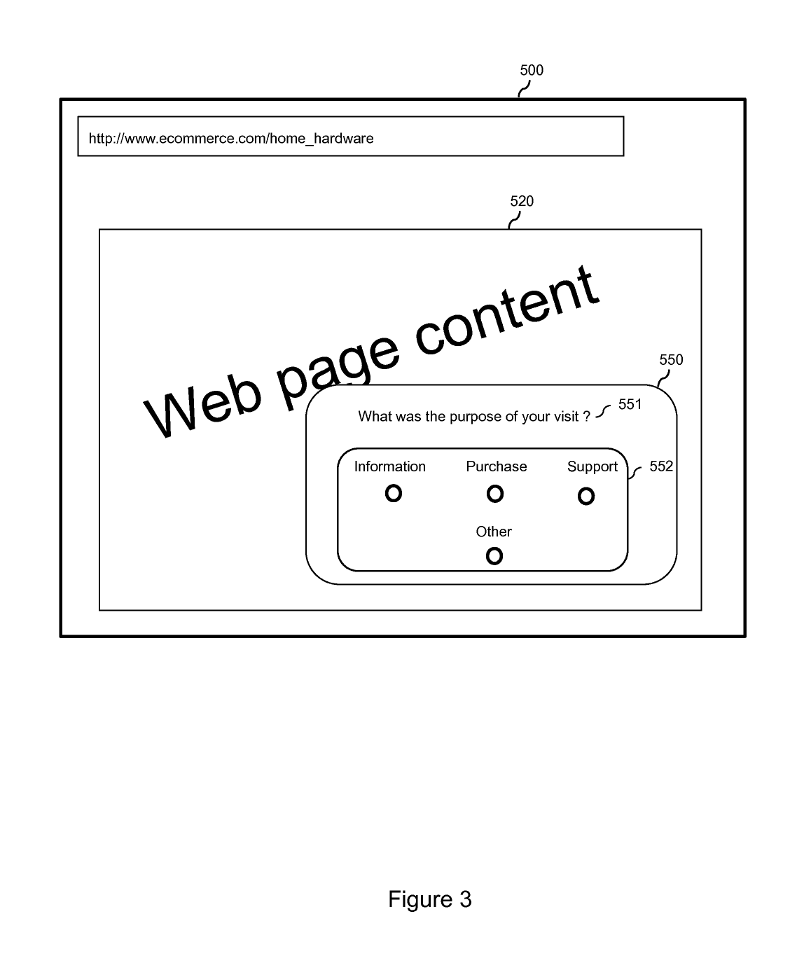

FIG. 3 illustrates an example of a web survey comprising a question for determining the intent of the users in relation to the visit of the website. A Graphical User Interface 500 of the browser executed by the processing unit 110 of the user device 100 displays web content related to the visited website (e.g. http://www.ecommerce.com) on the display 140 of the user device 100. A GUI 550 for allowing the user of the user device 100 to provide the survey information is also displayed on the display 140. For example, the GUI 550 consists in an overlay popup window partially covering a browsing window 520 containing the displayed web content (e.g. web page home_hardware).

A survey content displayed in the overlay popup window 550 comprises a closed-ended question 551 related to the intent of the user, and a selection widget 552 comprising four selectable items (information, purchase, support, other) corresponding to an intent of the user.

The interactions of the user with the GUI 550 (e.g. selection of one of the four items of the selection widget 552) generate survey participation data representative of the intent of the user for visiting the website. The survey participation data may comprise a value selected among pre-defined values (e.g. 1 for information, 2 for purchase, 3 for support, 4 for other) corresponding to the user intent metric.

In the embodiment illustrated in FIG. 3, upon reception of the survey participation data, the survey server 200 directly extracts the intent of the user from the survey participation data. In an alternative embodiment, the web survey does not include a question directly related to the intent of the user. Consequently, the intent of the user is inferred from the survey participation data, rather than being directly extracted from the survey participation data. For this purpose, at least some of the survey participation data are processed by the processing unit 210 of the survey server 200, to determine the intent of the user. This processing for determining the intent of the user is out of the scope of the present disclosure, but is well known in the art of analyzing survey participation data.

At step 425, the processing unit 210 of the survey server 200 analyzes the intent of the users and the related behavioral data to generate predictive user intent patterns.

As mentioned previously, a unique session identifier is used by the survey server 200 and a specific user device 100 for uniquely identifying the specific user device 100 when transmitting the behavioral data at step 411 and the survey participation data at step 416. This unique session identifier is used to associate the user intent determined at step 420 with the corresponding behavioral data for the specific user device 100. The unique session identifier can be generated by the survey server 200 (e.g. generation of a unique random number) and transmitted to the specific user device 100 before step 410. The unique session identifier can also be generated by the specific user device 100 (e.g. based on a unique characteristic of the specific user device 100). The unique session identifier can be stored in a cookie at the specific user device 100. Alternatively, a unique device identifier of the specific user device 100 (e.g. a Media Access Control (MAC) address, an International Mobile Station Equipment Identity (IMEI), an International Mobile Subscriber Identity (IMSI), etc.) can be used in place of (or complementarity to) the unique session identifier.

Step 425 is performed when a sufficient amount of intent of users and corresponding behavioral data have been collected from the user devices 100. Correlations between the intent of users and the corresponding behavioral data are inferred by the processing unit 210 of the survey server 200 through analysis of these data, and the predictive user intent patterns are generated based on these correlations. Based on the predictive user intent patterns, having only behavioral data for a particular user device 100, a corresponding intent of the user of the particular user device 100 for visiting the web site can be determined.

Techniques for the determination of correlations between two sets of data, and the generation of predictive patterns based on the correlations, is well known in the art of data analysis, and is out of the scope of the present disclosure. For instance, statistical and/or artificial intelligence (e.g. machine learning) techniques can be used for this purpose. Additionally, the generation of predictive patterns based on collected behavioral data and collected survey participation data is further described in U.S. application Ser. No. 14/288,347, the disclosure of which is incorporated herein in its entirety.

At step 450, the processing unit 210 of the survey server 200 stores the generated predictive user intent patterns in the memory 220, for use in the operational phase.

### Operational Phase (FIG. 2b)

During the operational phase, current user devices 100 visit a current website, and the predictive user intent patterns generated at step 425 and stored at step 450 are used to determine an intent of the users of the current user devices 100 in relation to the visiting the current web site.

The current website is generally the same as the website referred to in the learning phase. Thus, the predictive user intent patterns are generated when a sufficient number of user devices have been visiting the website for completing the collection of behavioral data at step 411 and survey participation data at step 416. Afterwards, the generated predictive user intent patterns are used for current user devices 100 visiting the website.

Alternatively, the current website is different from the website referred to in the learning phase, but their content is sufficiently related so that the user intent patterns generated for the website of the learning phase can be used for the current website. For example, the website of the learning phase and the current website may belong to the same industry (e.g. automotive, travel agencies, etc.), and respectively correspond to two different brands of a same company (e.g. two brands of cars from the same auto manufacturer).

At step 455, web content corresponding to the current website is transmitted by the web server 20 to a current user device 100 over the Internet 30. The current website is hosted by the web server 20 and visited by a user of the current user device 100. The current website may also be hosted by another web server. This step is similar to step 405.

The web content is displayed on the display 140 of the current user device 100 by the browser executed by the processing unit 110 of the current user device 100. The step of displaying the web content on the display 140 is not represented in FIG. 2B for simplification purposes. During a browsing session of the current web site, a sequence of web pages of the current website containing the web content is displayed on the display 140. The user of the current user device 100 interacts with the web content of the webpages through the user interface 150 of the current user device 100.

At steps 460 and 461, current behavioral data are respectively collected by the processing unit 110 of the current user device 100, and transmitted by the processing unit 110 from the current user device 100 to the survey server 200. The current behavioral data are representative of a series of actions performed by the user of the current user device 100 while visiting the current website. The current behavioral data are sent via the communication interface 130 of the current user device 100 and received via the communication interface 230 of the survey server 200. Steps 460 and 461 are similar to steps 410 and 411.

As mentioned previously for the behavioral data collected for the learning phase, at least some of the current behavioral data may be collected by a third party server (e.g. the web server 20) and/or transmitted to an intermediate third party server (e.g. an analytic server), before transmission to the survey server 200. Ultimately, the processing unit 210 of the survey server 200 collects the current behavioral data from the current user device 100, for further processing at step 465 of the method 400.

The current behavioral data are received via the communication interface 230 of the survey server 200, and may be stored in the memory 220. For instance, the current behavioral data of the current user device 100 may be received in several bundles, and aggregated in the memory 220 using a unique identifier of the current user device 100 (e.g. a unique session identifier or unique device identifier).

The processing unit 210 of the survey server 200 may also filter the collected current behavioral data, and discard some of them based on pre-determined criteria. The criteria may include at least one of the following: incomplete data, erroneous data, irrelevant data, etc. In particular, if some of the collected current behavioral data do not correspond to the type of behavioral data collected at steps 410 and 411 for the learning phase, they are discarded. The current behavioral data need to be of the same type/same scope as the behavioral data collected for the learning phase in order to obtain a relevant result at step 465.

At step 465, the processing unit 210 of the survey server 200 determines an intent of the user of the current user device 100 in relation to the visiting of the current website, based on the current behavioral data (collected at steps 460 and 461) and the predictive user intent patterns (generated at step 425 and stored at step 450). Step 465 leverages the learning phase, by using the predictive user intent patterns to guess the intent of the user for having visited the current website, without resorting to the collection of survey participation data for this purpose.

At step 470, the processing unit 210 of the survey server 200 transmits (via its communication interface, not represented in FIG. 1) the determined user intent to the current user device 100 over the Internet 10. The determined user intent is received by the processing unit 110 of the current device 100 via its communication interface 130. The determined user intent can be stored in memory 120 for future use, or can be processed immediately by the processing unit 110.

At step 475, the processing unit 110 of the current user device 100 transmits (via its communication interface 130) the determined user intent to the advertisement server 300 over the Internet 10. The determined user intent is received by the processing unit 310 of the advertisement server 300 via its communication interface (not represented in FIG. 1). The determined user intent can be stored in memory 320 for future use, or can be processed immediately by the processing unit 310.

At step 480, the processing unit 310 of the advertisement server 300 selects a retargeting advertisement directed to the current website for the current user device 100, based at least on the determined user intent transmitted at step 475. The advertisement server 300 may only take into consideration the determined user intent for selecting the retargeting advertisement directed to the current website. Alternatively, the advertisement server 300 takes into consideration the determined user intent in combination with other parameter(s) for selecting the retargeting advertisement directed to the current website. The retargeting advertisement being directed to the current website means that the purpose of the retargeting advertising is to influence the user of the current user device 100 to visit the current website again.

At step 485, the processing unit 310 of the advertisement server 300 transmits (via its communication interface, not represented in FIG. 1) the selected retargeting advertisement to the current user device 100 over the Internet 10. The selected retargeting advertisement is received by the processing unit 110 of the current device 100 via its communication interface 130.

At step 490, the processing unit 110 of the current user device 100 displays the selected retargeting advertisement on the display 140. The selected retargeting advertisement may consist of a banner, a video, a picture, etc. The selected retargeting advertisement is displayed when the user of the current user device 100 is visiting another website, and the displayed retargeting advertisement contains content directed to the current website, for driving the user to visit the current website again. For instance, by clicking on a displayed content of the retargeting advertisement, the web browser of the current user device 100 is redirected to the current website.

The execution of steps 475 and 480 depend on a specific implementation of the interactions between the current user device 100 and the advertisement server 300. For instance, the determined user intent received at step 470 by the current user device 100 may be stored in a cookie, along with an identifier of the current website (e.g. its URL). When the user of the current user device 100 visits another website, a script related to the advertisement server 300 is executed by the browser of the current user device 100, sending a request for an advertisement to the advertisement server 300. This request corresponds to step 475, and contains the determined user intent and the identifier of the corresponding website for which the user intent was determined. The request may contain a plurality of identifiers of websites previously visited by the user of the current user device 100, at least one of them having a corresponding user intent. The advertisement server 300 generally uses a biding algorithm for selecting one among the previously visited websites as candidate for advertisement retargeting (this step is not represented in FIG. 400, since it is well known in the art of retargeted advertisement). If the selected previously visited website is a website for which a user intent has been determined at step 465, and transmitted at steps 470 and 475, the advertisement server 300 further uses the determined user intent to select a particular retargeting advertisement directed to the selected previously visited website (at step 480). Taking into consideration the determined user intent allows for a selection of a particular retargeting advertisement more prone to driving the user to visit the selected previously visited website again.

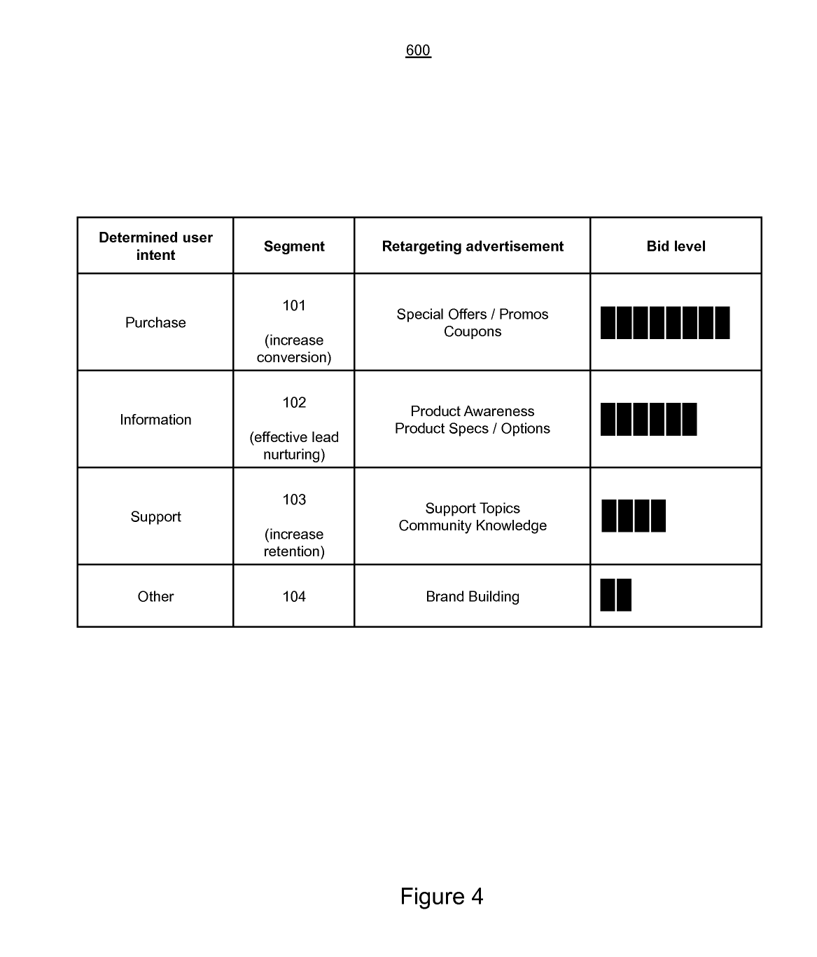

Alternatively or complementarily, the selection by the advertisement server 300 of a candidate for advertisement retargeting takes into consideration a plurality of pre-defined websites, each having a particular biding level which may be adjusted in real time. As mentioned previously, when the candidate website for advertisement retargeting is selected among the plurality of pre-defined websites, if a corresponding user intent for the candidate website is available, is it used at step 480 for selecting a particular retargeting advertisement more prone to driving the user to visit the selected candidate website again. The selection of the particular retargeting advertisement based on the determined intent will be detailed later in the description, in relation to FIG. 4.

The determined user intent received by the current user device 100 at step 470, during the visit of the current website, may be transmitted to the advertisement server 300 (step 475) immediately (along with an identifier of the corresponding current web site). The determined intent (along with the identifier of the current website) is stored in the memory 320 of the advertisement server 300. The determined user intent is used later when the current user device 100 visits another website, and requests the advertisement server 300 to select a retargeting advertisement. Alternatively, the determined user intent is stored in the memory 120 (e.g. via a cookie) of the current user device 100 (along with an identifier of the corresponding current web site). When the current user device 100 visits another website, and requests the advertisement server 300 to select a retargeting advertisement, the determined user intent is transmitted to the advertisement server 300 (step 475), along with the identifier of the corresponding web site.

Although the learning phase and the operational phase have been represented sequentially in FIGS. 2A and 2B for simplification purposes, they may also occur simultaneously. For instance, the learning phase may be performed solely until satisfying user intent patterns have been generated at step 425 of the method 400. For example, the generated user intent patterns are satisfying if they allow to determine a user intent at step 465 of the method 400 with a pre-defined level of accuracy (e.g. 95% of the predicted user intents are accurate). Then, the operational phase is performed, but the learning phase can still be performed simultaneously to improve/update the user intent patterns generated at step 425 of the method 400.

In a particular aspect, the user intent for visiting a website comprises at least one of the following: information, purchase and support. The user intent being information corresponds to a user visiting the website for obtaining information about a product, a service, etc. presented on the website. The user intent being purchase corresponds to a user visiting the website for purchasing a product, a service, etc. available through the website. The user intent being support corresponds to a user visiting the website for obtaining support via the website for a product or service previously purchased by the user.

Other types of user intent may be determined at steps 420 and 465 of the method 400, such as for example: a purpose of visit, a purchase horizon, a purchase stage, a channel of choice (e.g. online versus offline), an intent of travel (e.g. business versus leisure), etc. The present method 400 can be applied to a variety of websites, and for each particular website, a list of relevant user intents can be determined based on the specificities of the particular website. The list of relevant user intents can be submitted to a visitor of the particular website via a survey, as illustrated in FIG. 3, to collect survey participation data comprising the user intent at step 415 of the method 400.

In another particular aspect, the behavioral data collected at steps 410 and 460 of the method 400 comprise at least one of the following: a time spent on a web page, a scrolling activity on a web page, a backtracking activity on a web page, an action firing activity on a web page, a comment card filing activity, an exit activity on a web page, and a hit activity on a web page. The web page is a web page of the website for step 410 (learning phase) and a web page of the current website for step 460 (operational phase). As mentioned previously, the website for the learning phase and the current website (for the operational phase) are generally the same, but may be different.

The time spent on a web page is a duration which can be measured in seconds. The scrolling activity on a web page can be measured by the number of times the user of the user device 100 has scrolled the web page either horizontally or vertically (the action of scrolling a web page is well known in the art). The backtracking activity on a web page can be measured by the number of times the user of the user device 100 has come back to the web page from another web page of the web site during a pre-defined interval of time. The action firing activity on a web page can be measured by the number of times the user of the user device 100 has performed a specific action among a plurality of pre-defined actions (e.g. clicking on a download button, accessing a cart, etc.). The plurality of pre-defined actions depends on the design and function of the web page. The comment card filing activity can be measured by the number of times the user of the user device 100 has filed a comment card. In a particular embodiment, only comment card(s) associated to the web page may be taken into consideration. In another embodiment, comment card(s) associated to the entire website are taken into consideration. The exit activity on a web page can be measured by an occurrence of the user of the user device 100 exiting the website from the web page. The hit activity on a web page can be measured by a number of occurrences of the user of the user device 100 accessing the web page.

In still another particular aspect, the method 400 comprises determining a bid level based at least on the determined intent of the user of the current device 100. The determination of the bid level can be performed by the processing unit 310 of the advertisement server 300, for example at step 480 of the method 400. The determination of the bid level can also be performed by the processing unit 110 of the current user device 100, for example between steps 470 and 475 of the method 400 (the bid level is then transmitted to the advertisement server 300 at step 475, along with the determined intent). The bid level determines a price that a brand owner is ready to pay for having a retargeting advertisement related to its brand served to the current user device 100 by the survey server 300. The survey server 300 generally implements an auction process, to take into consideration the bid levels offered by the brands in the selection of which retargeting advertisement (corresponding to a particular brand) to serve.

FIG. 4 illustrates examples of the determination of bid levels based on determined user intent. If the determined intent is purchase, the bid level has the highest value since a conversion of the user is the most likely to happen. Decreasing values for the bid level are associated respectively with the determined user intent being information, support and other; since the probably of converting the user decreases accordingly.

In yet another particular aspect, the selection of the retargeting advertisement directed to the current website for the current user device 100 at step 480 of the method 400 also takes into consideration complementary behavioral data collected from the current user device 100. The complementary behavioral data consist in behavioral data collected by the advertisement server 300 for performing standard behavioral retargeting based on collected behavioral data. The complementary behavioral data may at least partially overlap with the current behavioral data collected at step 460, or may be totally different from them. The advertisement server 300 may determine a candidate user intent based on the complementary behavioral data, and refine/correct the candidate user intent based on the determined user intent transmitted at step 475. Then, step 480 of the method 400 is based on the refined/corrected candidate user intent.

In another particular aspect, for the learning phase, the behavioral data collected from the plurality of user devices 100 (steps 410 and 411 of the method 400) and the survey participation data collected from at least some of the plurality of user devices 100 (steps 415 and 416 of the method 400) correspond to a plurality of websites visited by the users of the user devices 100. For example, the plurality of websites belong to the same industry (e.g. automotive, travel agencies, etc.), and respectively correspond to several brands of a same company (e.g. several brands of cars from the same auto manufacturer). Thus, the mechanism (e.g. statistical and/or artificial intelligence method) for determining a user intent based on current behavioral data and user intent patterns is trained (step 425 of the method 400) with data from the plurality of websites. The user intent patterns can then be used at step 465 of the method 400 for current behavioral data collected from at least one current website.

In still another particular aspect, the method 400 comprises generating audience segments based at least on the intents of the users. The audience segments may be generated by the processing unit 310 of the advertisement server 300 and stored in its memory 320. Alternatively, the audience segments are generated by a third party entity, transmitted to the advertisement server 300, and stored in its memory 320. FIG. 4 illustrates four audience segments (101, 102, 103 and 104) respectively corresponding to the following user intents: purchase, information, support and other. Identifiers of the audience segments (e.g. 101, 102, 103 and 104) can be used for identifying the audience segments when exchanging data between the advertisement server 300 and other entities, such as the current user device 100.

The selection at step 480 of a retargeting advertisement directed to the current website for the current user device 100 is based on the user of the current user device 100 belonging to a specific audience segment among the generated audience segments (e.g. 101, 102, 103 and 104). For instance, the objective of the retargeting advertisement for segment 101 (purchase intent) is to increase conversion. Consequently, the retargeting advertisement may consist of special offers, promotions, coupons, etc. The objective of the retargeting advertisement for segment 102 (information intent) is to perform an effective lead nurturing. Consequently, the retargeting advertisement may be directed to product awareness, product specifications, product options, etc. The objective of the retargeting advertisement for segment 103 (support intent) is to increase customer retention. Consequently, the retargeting advertisement may be directed to support topics, community knowledge, etc. The objective of the retargeting advertisement for segment 104 (other intent) is to address users for whom no specific intent has been determined. Consequently, the retargeting advertisement may consist of brand building, etc.

The present disclosure also relates to a computer program product. Instructions of a computer program implement steps of the method 400 when executed by the processing unit 110 of the user device 100. The instructions are comprised in the computer program product (e.g. memory 120), and provide for advertisement retargeting based on a determined user intent, when executed by the processing unit 110. The instructions comprised in the computer program product are deliverable via an electronically-readable media, such as a storage media (e.g. a USB key or a CD-ROM) or communication links (e.g. via the Internet 10 through the communication interface 130 of the user device 100).

The instructions comprised in the computer program product more specifically implement steps of the method 400 illustrated in FIG. 2B and corresponding to the aforementioned operational phase. The instructions are executed by the processing unit 110 of the aforementioned current user device 100.

The execution of the instructions provides for collecting behavioral data representative of a series of actions performed by a user of the current user device 100 while visiting a website (step 460).

The execution of the instructions provides for transmitting the collected behavioral data to the survey server 200 (step 461), via the communication interface 130 over the Internet 10.

The execution of the instructions provides for receiving a determined intent of the user of the current user device 100 from the survey server 200 (step 470), via the communication interface 130 over the Internet 10. The intent of the user has been determined based on the collected behavioral data and the predictive user intent patterns by the survey server 200.

The execution of the instructions provides for transmitting the determined intent to the advertising server 300 (step 475), via the communication interface 130 over the Internet 10.

The execution of the instructions provides for receiving a retargeting advertisement directed to the website from the advertising server 300 (step 485), via the communication interface 130 over the Internet 10. The retargeting advertisement has been selected at least based on the determined intent by the advertisement server 300.

The execution of the instructions provides for displaying the retargeting advertisement on the display 140 of the current user device 100 while visiting another website (step 490).

Although the present disclosure has been described hereinabove by way of non-restrictive, illustrative embodiments thereof, these embodiments may be modified at will within the scope of the appended claims without departing from the spirit and nature of the present disclosure.

1. A method for advertisement retargeting based on predictive user intent patterns, comprising:
collecting by a processing unit of a survey server behavioral data from a plurality of user devices, the behavioral data being representative of a series of actions performed by a user of each of the plurality of user devices while visiting a website;
collecting by the processing unit of the survey server survey participation data from at least some of the plurality of user devices, the survey participation data corresponding to survey information received from the users of the at least some of the plurality of user devices in relation to the visiting of the website, the survey participation data comprising one or more responses from the users to a survey questionnaire related to the website;
determining by the processing unit of the survey server an intent of the users of the at least some of the plurality of user devices in relation to the visiting of the website based on the survey participation data;
analyzing by the processing unit of the survey server the intent of the users and the related behavioral data to generate the predictive user intent patterns, the analysis comprising generating correlations between the intent of the users determined based on the survey participation data comprising the one or more responses to the survey questionnaire and the related behavioral data;
collecting by the processing unit current behavioral data from a current user device, the current behavioral data being representative of a series of actions performed by a user of the current user device while visiting a current website;
determining by the processing unit of the survey server an intent of the user of the current user device in relation to the visiting of the current website based on the current behavioral data and the predictive user intent patterns; and
selecting by the processing unit of the survey server a retargeting advertisement directed to the current website for the current user device based at least on the determined intent of the user of the current device.

2. The method of claim 1, wherein the intent of a user comprises at least one of the following: information, purchase and support.

3. The method of claim 1, further comprising transmitting the selected retargeting advertisement to the current user device.

4. The method of claim 1, wherein the current website corresponds to the website.

5. The method of claim 1, wherein the current website is different from the website.

6. The method of claim 1, further comprising determining a bid level based at least on the determined intent of the user of the current device.

7. The method of claim 1, wherein the selection of the retargeting advertisement for the current user device also takes into consideration complementary behavioral data collected from the current user device.

8. The method of claim 1, further comprising generating by the processing unit of the survey server audience segments based at least on the intents of the users, the selection of a retargeting advertisement for the current user device being based on the user of the current user device belonging to a specific audience segment among the generated audience segments.

9. The method of claim 1, wherein the behavioral data collected from the plurality of user devices and the survey participation data collected from at least some of the plurality of user devices correspond to a plurality of websites visited by the users of the user devices.

10. The method of claim 1, wherein the behavioral data and the current behavioral data comprise at least one of the following: a time spent on a web page, a scrolling activity on a web page, a backtracking activity on a web page, an action firing activity on a web page, a comment card filing activity, an exit activity on a web page, and a hit activity on a web page.

11. A non-transitory computer program product comprising instructions deliverable via an electronically-readable media, such as storage media and communication links, the instructions when executed by a processing unit of a user device providing for advertisement retargeting based on a determined user intent by:
collecting behavioral data representative of a series of actions performed by a user of the user device while visiting a website;
transmitting the collected behavioral data to a survey server capable of determining an intent of the user of the user device in relation to the visiting of the website based on the collected behavioral data and predictive user intent patterns, the predictive user intent patterns being generated by the survey server based on correlations between survey participation data comprising one or more responses to a survey questionnaire and related behavioral data;
receiving the determined intent of the user of the user device in relation to the visiting of the website from the survey server;
transmitting the determined intent to an advertising server; and
receiving a retargeting advertisement directed to the website from the advertising server, the retargeting advertisement being selected at least based on the determined intent.

12. The computer program product of claim 11, wherein the determined intent of the user comprises at least one of the following: information, purchase and support.

13. The computer program product of claim 11, wherein the retargeting advertisement is displayed on a display of the user device while visiting another website.

14. The computer program product of claim 11, wherein the collected behavioral data comprise at least one of the following: a time spent on a web page, a scrolling activity on a web page, a backtracking activity on a web page, an action firing activity on a web page, a comment card filing activity, an exit activity on a web page, and a hit activity on a web page.

15. A system for advertisement retargeting based on predictive user intent patterns, comprising:
a survey server comprising:
a communication interface for exchanging data with user devices;
memory for storing the predictive user intent patterns;
a processing unit for:
collecting behavioral data from a plurality of user devices, the behavioral data being representative of a series of actions performed by a user of each of the plurality of user devices while visiting a website;
collecting survey participation data from at least some of the plurality of user devices, the survey participation data corresponding to survey information received from the users of the at least some of the plurality of user devices in relation to the visiting of the website, the survey participation data comprising one or more responses from the users to a survey questionnaire related to the website;
determining an intent of the users of the at least some of the plurality of the user devices in relation to the visiting of the website based on the survey participation data;
analyzing the intent of the users and the related behavioral data to generate the predictive user intent patterns, the analysis comprising generating correlations between the intent of the users determined based on the survey participation data comprising the one or more responses to the survey questionnaire and the related behavioral data;
collecting current behavioral data from a current user device, the current behavioral data being representative of a series of actions performed by a user of the current user device while visiting a current website;
determining an intent of the user of the current user device in relation to the visiting of the current website based on the current behavioral data and the predictive user intent patterns;
transmitting the determined intent to the current user device;
an advertisement server comprising:
a communication interface for exchanging data with user devices;
a processing unit for:
receiving the determined intent from the current user device;
selecting a retargeting advertisement directed to the current website for the current user device based at least on the determined intent.

16. The system of claim 15, wherein the intent of a user comprises at least one of the following: information, purchase and support.

17. The system of claim 15, further comprising transmitting the selected retargeting advertisement to the current user device.

18. The system of claim 15, further comprising determining by the processing unit of the advertisement server a bid level based at least on the determined intent.

19. The system of claim 15, further comprising receiving by the processing unit of the advertisement server complementary behavioral data collected from the current user device, the selection of the retargeting advertisement for the current user device also taking into consideration the complementary behavioral data.

20. The system of claim 15, wherein the behavioral data and the current behavioral data comprise at least one of the following: a time spent on a web page, a scrolling activity on a web page, a backtracking activity on a web page, an action firing activity on a web page, a comment card filing activity, an exit activity on a web page, and a hit activity on a web page.
